(19) United States
(12) Patent Application Publication
(10) Pub. No.: US 2007/0242649 A1
(43) Pub. Date: Oct. 18, 2007

(54) Integrating camp-on telephony feature with WLAN resource management and admission control

(75) Inventors: Rajneesh Kumar, San Jose, CA (US); Ashish Chotai, Santa Clara, CA (US); Aseem Asthana, San Jose, CA (US); Sravan Vadlakonda, Sunnyvale, CA (US); Girish Variyath, San Jose, CA (US); Vikram Jayaraman, Milpitas, CA (US); Pradeep Bheda, Santa Clara, CA (US)

Correspondence Address: LAW OFFICE OF MARK J. SPOLYAR, 2200 CESAR CHAVEZ STREET, SUITE 8, SAN FRANCISCO, CA, 94124, US

(73) Assignee: Cisco Technology, Inc., San Jose, CA (US)

(21) Appl. No.: 11/405,319

(22) Filed: Apr. 17, 2006

(51) Int. Cl. H04Q 7/28

(52) U.S. Cl. 370/341; 370/329

(57) ABSTRACT

In one embodiment, a method for requesting wireless network resources includes transmitting a network resource request to a wireless network in response to a session initiation message from a session signaling node and, responsive to an indication that the wireless network lacks sufficient resources, conditionally transmitting a camp-on information message to the session signaling node.

### FIELD OF THE INVENTION

The present invention relates to wireless networks and, more particularly, to methods, apparatuses, and systems directed to facilitating communication and resource management in wireless networks.

### BACKGROUND OF THE INVENTION

Market adoption of wireless LAN (WLAN) technology has exploded, as users from a wide range of backgrounds and vertical industries have brought this technology into their homes, offices, and increasingly into the public air space. This inflection point has highlighted not only the limitations of earlier-generation systems, but also the changing role that WLAN technology now plays in people's work and lifestyles, across the globe. Indeed, WLANs are rapidly changing from convenience networks to business-critical networks. Increasingly users are depending on WLANs to improve the timeliness and productivity of their communications and applications, and in doing so, require greater visibility, security, management, and performance from their network.

### DESCRIPTION OF THE DRAWINGS

FIG. 1A is a topological diagram of the components in a wireless local area network (WLAN) system according to one implementation of the present invention.

FIG. 1B illustrates a hierarchical wireless network including a central controller according to one implementation of the present invention.

FIG. 1C illustrates for didactic purposes a hardware system, which may be used to implement a central controller.

FIG. 2 illustrates for didactic purposes a hardware system, which may be used to implement an Internet Protocol Private Branch Exchange (IP-PBX).

FIG. 3 illustrates for didactic purposes a hardware system, which may be used to implement a wireless access point.

FIG. 4 illustrates for didactic purposes a hardware system, which may be used to implement a wireless client.

FIG. 5 is a diagram illustrating information flow within a WLAN system in accordance with one implementation of the present invention.

FIG. 6 is a flow chart illustrating a process flow, according to one implementation of the present invention, implemented at a wireless client.

FIG. 7 is a flow chart illustrating a process flow, according to one implementation of the present invention, implemented at a wireless client and resource tracking agent (WCRTA).

FIG. 8 is a flow chart illustrating a process flow, according to one implementation of the present invention, implemented at an IP-PBX.

FIG. 9 is a diagram illustrating information flow within a WLAN system in accordance with one implementation of the present invention.

FIG. 10 is a flow chart illustrating a process flow, according to one implementation of the present invention, implemented at a wireless client.

FIG. 11 is a diagram illustrating information flow within a WLAN system in accordance with one implementation of the present invention.

FIG. 12 is a flow chart illustrating a process flow, according to one implementation of the present invention, implemented at a wireless client.

FIG. 13 is a flow chart illustrating a process flow, according to one implementation of the present invention, implemented at a wireless client.

### DESCRIPTION OF EXEMPLARY EMBODIMENTS

A. Overview

Particular embodiments of the present invention facilitate communication and resource management in wireless networks. In one implementation, the wireless network infrastructure integrates a telephony camp-on feature to facilitate establishing a call when resources of the wireless network infrastructure are temporarily unavailable. According to one implementation, when a called wireless client is not reachable due to unavailable resources (e.g., “circuit busy”), the IP-PBX may “camp-on” on behalf of the calling wireless client, whereby a call manager such as an Internet Protocol Private Branch Exchange (IP-PBX) calls the calling wireless client back when sufficient resources become available. As described in further detail below, in one implementation, when the wireless network infrastructure temporarily lacks resources to support the call, the wireless network infrastructure initiates a message flow that associates the called wireless client with the camp-on feature. In one implementation, the wireless network infrastructure initiates a message flow to activate the camp-on feature. In an alternative implementation, the calling wireless client initiates a message flow to activate the camp-on feature. These messages flows involve the operations of one or more of the called wireless client, the calling wireless client, an access control module (ACM), a resource tracking agent (referred to as a wireless client and resource tracking agent (WCRTA)), and the IP-PBX, which are described in detail below.

B. Exemplary Wireless Network System Architecture

B.1. Network Topology

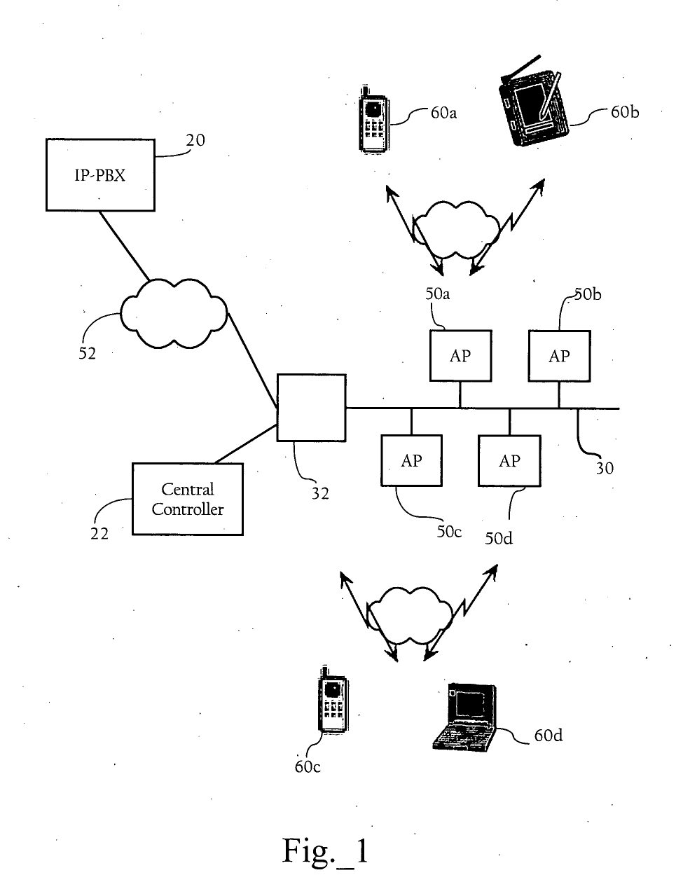

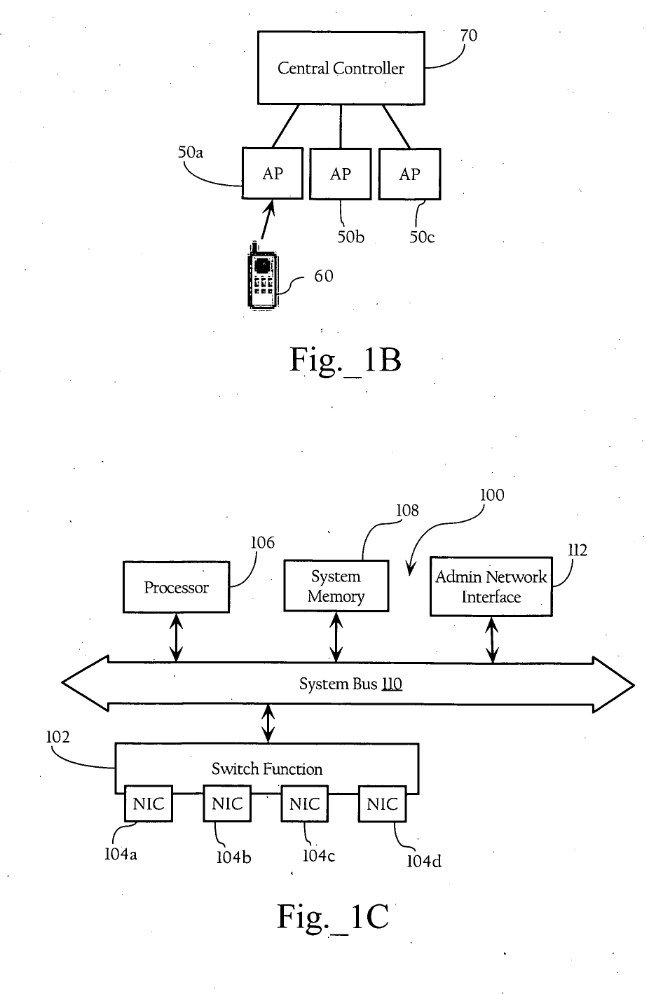

A network environment including a wireless local area network (WLAN) according to one implementation of the present invention is shown in FIG. 1A. In a specific embodiment of the present invention, the system includes an Internet Protocol Private Branch Exchange (IP-PBX) 20, a central controller 22, a local area network (LAN) 30, a router 32, and wireless access points 50a, 50b, 50c, and 50d (collectively referred to as wireless access points 50). LAN 30 is implemented by a switch (or an array of switches) and/or other network devices, such as a bridge.

As FIG. 1A illustrates, these network elements are operably connected to a network 52. Network 52, in one implementation, generally refers to a computer network, such as a LAN, a WAN, etc., that includes one or more intermediate network devices (e.g., routers, switches, etc.), which allow for the transmission of messages between IP-PBX 20 and wireless clients via wireless access points 50. Of course, network 52 can include a variety of network segments, transmission technologies and components, such as terrestrial WAN links, satellite links, optical fiber links, and cellular links; network 52 could also be a campus LAN. LAN 30 may be a LAN or LAN segments implemented by an Ethernet switch (not shown) or an array of switches having multiple ports to which wireless access points 50 are connected. The wireless access points 50 are typically connected to switch ports via Ethernet links; however, other link layer connection protocols or communication means can be employed. FIG. 1A illustrates one possible network environment in which the invention may operate; however, other implementations are possible. For example, although IP-PBX 20 is illustrated as being on a different LAN or LAN segment, it may be co-located with wireless access points 50.

The wireless access points 50 are operative to wirelessly communicate with remote wireless client devices 60a, 60b, 60c, and 60d. In one implementation, the wireless access points 50 implement the wireless network protocol specified in the IEEE 802.11 WLAN specification. The wireless access points 50 may be autonomous or so-called “fat” wireless access points, or light-weight wireless access points operating in connection with a wireless switch (see FIG. 1B). In addition, the network infrastructure may also include a Wireless LAN Solution Engine (WLSE) offered by Cisco Systems, Inc. of San Jose, Calif. or another wireless network management system. In some implementations, the network infrastructure may also include one or more Wireless Control System (WCS) nodes operative to manage one or more wireless switches and access points.

B.2. Central Controller

FIG. 1B illustrates a hierarchical wireless network including a central controller 70, which may be used implement the central controller 22 of FIG. 1A according to one implementation of the present invention. In one implementation, the central controller 70 may be implemented as a wireless domain server (WDS) or, alternatively, as a wireless switch. If the central controller 70 is implemented with a WDS, the central controller 70 is operative to communicate with autonomous or so-called “fat” wireless access points. If the central controller 70 is implemented as a wireless switch (such as the Cisco Wireless Controller 4400 offered by Cisco Systems, Inc. of San Jose, Calif.), the central controller 70 is operative to communicate with light-weight wireless access points and process wireless protocol and network management information.

FIG. 1C illustrates for didactic purposes a hardware system 100, which may be used to implement a central controller 70 of FIG. 1B. As FIG. 1C shows, in one implementation, the central control elements each comprise a switch function or fabric 102 comprising a network interface 104a (e.g., a Ethernet adapter) for connection to network 52 and corresponding network interfaces 104b, 104c, and 104d for connection to the access elements, a processor 106, a memory 108, one or more software modules, stored in memory 108, including instructions for performing the functions described herein, and a system bus 110 operably connecting these components. The central control elements may optionally include an administrative network interface 112 allowing for administrative access for such purposes as configuration and diagnostic access. In other implementations, central controller 70 includes a single network interface.

B.2. Internet Protocol Private Branch Exchange (IP-PBX)

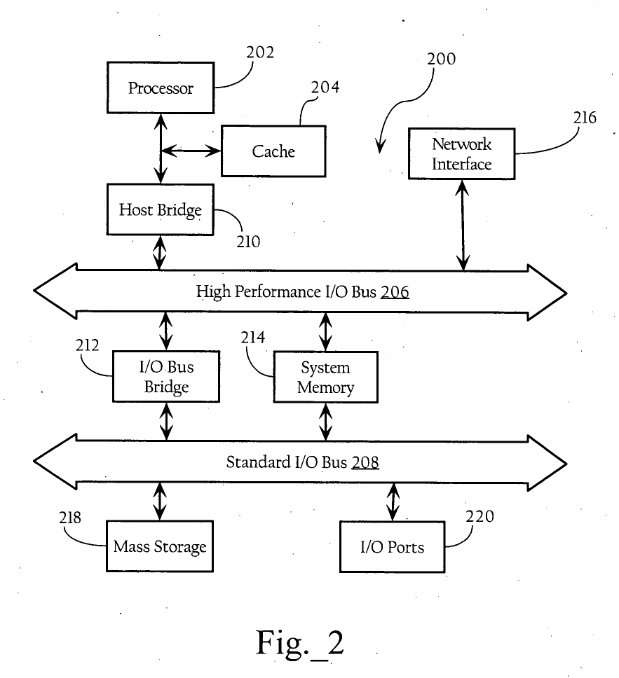

FIG. 2 illustrates for didactic purposes a hardware system 200, which may be used to implement an IP-PBX 20. In one implementation, hardware system 200 comprises a processor 202, a cache memory 204, and one or more software applications and drivers directed the functions described herein. Additionally, hardware system 200 includes a high performance input/output (I/O) bus 206 and a standard I/O bus 208. A host bridge 210 couples processor 202 to high performance I/O bus 206, whereas I/O bus bridge 212 couples the two buses 206 and 208 to each other. A system memory 214 and a network/communication interface 216 couple to bus 206. Hardware system 200 may further include video memory (not shown) and a display device coupled to the video memory. Mass storage 218 and I/O ports 220 couple to bus 208. Hardware system 200 may optionally include a keyboard and pointing device (not shown) coupled to bus 208. Collectively, these elements are intended to represent a broad category of computer hardware systems, including but not limited to general purpose computer systems based on the Pentium® processor manufactured by Intel Corporation of Santa Clara, Calif., as well as any other suitable processor.

The elements of hardware system 200 are described in greater detail below. In particular, network interface 216 provides communication between hardware system 200 and any of a wide range of networks, such as an Ethernet (e.g., IEEE 802.3) network, etc. Mass storage 218 provides permanent storage for the data and programming instructions to perform the above described functions implemented in the system controller, whereas system memory 214 (e.g., DRAM) provides temporary storage for the data and programming instructions when executed by processor 202. I/O ports 220 are one or more serial and/or parallel communication ports that provide communication between additional peripheral devices, which may be coupled to hardware system 200.

Hardware system 200 may include a variety of system architectures, and various components of hardware system 200 may be rearranged. For example, cache 204 may be on-chip with processor 202. Alternatively, cache 204 and processor 202 may be packed together as a “processor module,” with processor 202 being referred to as the “processor core.” Furthermore, certain implementations of the present invention may not require nor include all of the above components. For example, the peripheral devices shown coupled to standard I/O bus 208 may couple to high performance I/O bus 206. In addition, in some implementations only a single bus may exist with the components of hardware system 200 being coupled to the single bus. Furthermore, hardware system 200 may include additional components, such as additional processors, storage devices, or memories.

As discussed above, in one embodiment, the operations of the IP-PBX 20 described herein are implemented as a series of software routines run by hardware system 200. These software routines comprise a plurality or series of instructions to be executed by a processor in a hardware system, such as processor 202. Initially, the series of instructions are stored on a storage device, such as mass storage 218. However, the series of instructions can be stored on any suitable storage medium, such as a diskette, CD-ROM, ROM, etc. Furthermore, the series of instructions need not be stored locally, and could be received from a remote storage device, such as a server on a network, via network/communication interface 216. The instructions are copied from the storage device, such as mass storage 218, into memory 214 and then accessed and executed by processor 202.

An operating system manages and controls the operation of hardware system 200, including the input and output of data to and from software applications (not shown). The operating system provides an interface between the software applications being executed on the system and the hardware components of the system. According to one embodiment of the present invention, the operating system is the Windows® 95/98/NT/XP operating system, available from Microsoft Corporation of Redmond, Wash. However, the present invention may be used with other suitable operating systems, such as the Apple Macintosh Operating System, available from Apple Computer Inc. of Cupertino, Calif., UNIX operating systems, LINUX operating systems, and the like.

B.3. Wireless Access Point

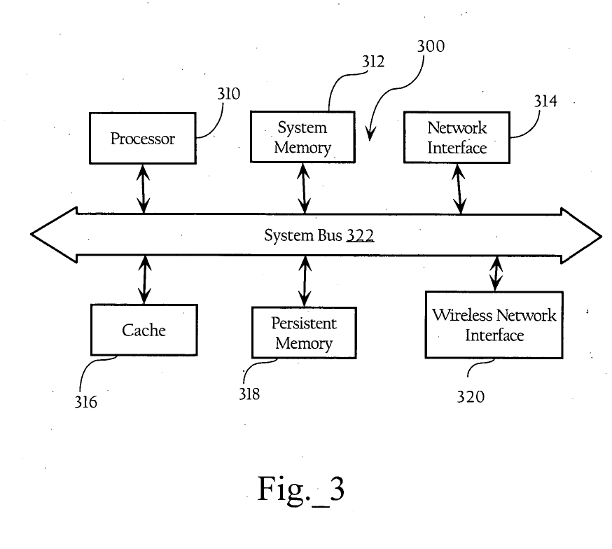

FIG. 3 illustrates for didactic purposes a hardware system 300, which may be used to implement a wireless access point 50. In one implementation, the wireless access point 300 comprises a processor 310, a memory 312, a network interface 314 (e.g., an 802.3 interface) for communication with a LAN, a cache 316 for storing WLAN information, a persistent memory 318, a wireless network interface 320 (e.g., an IEEE 802.11 WLAN interface) for wireless communication with one or more wireless clients 60, and a system bus 322 interconnecting these components. The wireless access points 50 may also include software modules (including Dynamic Host Configuration Protocol (DHCP) clients, transparent bridging, Lightweight Access Point Protocol (LWAPP), Cisco® Discovery Protocol (CDP) modules, wireless access point modules, Simple Network Management Protocol (SNMP) functionality, etc., and device drivers (e.g., network and WLAN interface drivers) stored in persistent memory 318 (e.g., a hard disk drive, flash memory, EEPROM, etc.). At start up, these software components are loaded into system memory 312 and then accessed and executed by processor 310.

B.4. Wireless Client

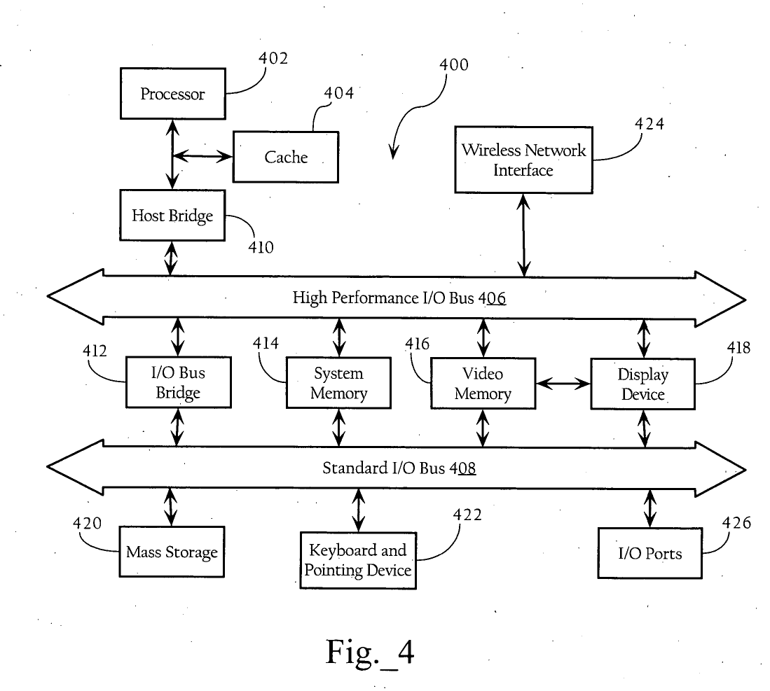

FIG. 4 illustrates for didactic purposes a hardware system 400, which may be used to implement a wireless client 60. In one embodiment, hardware system 400 includes a processor 402 and a cache memory 404 coupled to each other as shown. Additionally, hardware system 400 includes a high performance input/output (I/O) bus 406 and a standard I/O bus 408. A host bridge 410 couples processor 402 to high performance I/O bus 406, whereas an I/O bus bridge 412 couples the two buses 406 and 408 to each other. A wireless network interface 424, a system memory 414, and a video memory 416 couple to bus 406. In turn, a display device 418 couples to video memory 416. A mass storage 420, a keyboard and pointing device 422, and I/O ports 426 couple to bus 408. Collectively, these elements are intended to represent a broad category of computer hardware systems, including but not limited to general purpose computer systems based on the Pentium® processor manufactured by Intel Corporation of Santa Clara, Calif., as well as any other suitable processor.

The remaining elements of hardware system 400 are described below. In particular, wireless network interface 424 provides communication between hardware system 400 and any of a wide range of wireless networks, such as a WLAN (i.e., IEEE 802.11), WiMax (i.e., IEEE 802.16), Cellular (e.g., GSMA), etc. Mass storage 420 provides permanent storage for the data and programming instructions to perform the above described functions implemented in the system controller, whereas system memory 414 (e.g., DRAM) is used to provide temporary storage for the data and programming instructions when executed by processor 402. I/O ports 426 are one or more serial and/or parallel communication ports that provide communication between additional peripheral devices, which may couple to hardware system 400.

Hardware system 400 may include a variety of system architectures; and various components of hardware system 400 may be rearranged. For example, cache 404 may be on-chip with processor 402. Alternatively, cache 404 and processor 402 may be packed together as a “processor module,” with processor 402 being referred to as the “processor core.” Furthermore, certain implementations of the present invention may not require nor include all of the above components. For example, the peripheral devices shown coupled to standard I/O bus 408 may couple to high performance I/O bus 406. In addition, in some implementations only a single bus may exist, with the components of hardware system 400 being coupled to the single bus. Furthermore, hardware system 400 may include additional components, such as additional processors, storage devices, or memories.

In one embodiment, the operations of wireless client-side functionality are implemented as a series of software routines run by hardware system 400. These software routines, which can be embodied in a wireless network interface driver, comprise a plurality or series of instructions to be executed by a processor in a hardware system, such as processor 402. Initially, the series of instructions are stored on a storage device, such as mass storage 420. However, the series of instructions can be stored on any suitable storage medium, such as a diskette, CD-ROM, ROM, etc. Furthermore, the series of instructions need not be stored locally, and could be received from a remote storage device, such as a server on a network, via network/communication interface 424. The instructions are copied from the storage device, such as mass storage 420, into memory 414 and then accessed and executed by processor 402. In alternate embodiments, the present invention is implemented in hardware or firmware.

While FIG. 4 illustrates, for didactic purposes, the hardware architecture of a wireless client according to one implementation of the present invention, the wireless client, however, may be implemented on a wide variety of computer system architectures, such as dual-mode cellular phones (e.g., cellular plus 802.11 capable devices), wireless VoIP phones, Personal Digital Assistants (e.g., converged devices which support WLAN data+voice and cellular), Laptop computers, and the like. An operating system manages and controls the operation of hardware system 400, including the input and output of data to and from software applications (not shown). The operating system provides an interface, such as a graphical user interface (GUI), between the user and the software applications being executed on the system. According to one embodiment of the present invention, the operating system is the Windows® 95/98/NT/XP operating system and/or Windows® CE (WinCE) operating system, available from Microsoft Corporation of Redmond, Wash. However, the present invention may be used with other operating systems, such as the Apple Macintosh Operating System, available from Apple Computer Inc. of Cupertino, Calif., UNIX operating systems, LINUX operating systems, Symbian operating systems, and the like.

C. Camp-On Feature Integration into Wireless Network Infrastructure

The wireless network infrastructure integrates a telephony camp-on feature with wireless network infrastructures to facilitate a call when sufficient resources of the wireless network infrastructure are temporarily unavailable. As described herein, the integrated camp-on functionality can operate in connection with called or calling wireless clients associated with a given wireless network. According to one implementation of the present invention, when the wireless network does not have sufficient resources to support a call corresponding to a called wireless client, the IP-PBX may “camp-on” to the wireless network infrastructure on behalf of the calling wireless client, whereby the IP-PBX notifies the calling wireless client when sufficient resources becomes available. When sufficient resources are available, the IP-PBX and the wireless client implement camp-on functionality to establish the call. For calling wireless clients, when the wireless network infrastructure lack sufficient resources for a call, the wireless network may be configured to notify the wireless client when sufficient resources are available, allowing the wireless client to establish a call at that time.

In one implementation, the wireless network infrastructure utilizes an extended Session Initiation Protocol (SIP) message from the calling wireless client to the IP-PBX when a VoIP call fails due to a TSPEC failure. The wireless network infrastructure may also initiate communication among the IP-PBX, the called wireless client, the calling wireless client, an access control module (ACM), and a resource tracking agent (WCRTA). Operation of the ACM and WCRTA are described below.

In one implementation, the ACM and WCRTA are located at the central controller 70. However, the ACM and the WCRTA may reside on any suitable host or node and need not be collocated on the same host or hosts. Alternatively, the ACM and WCRTA may be located at other suitable nodes of the wireless network infrastructure, such as at one or more wireless access points, wireless distribution system nodes, wireless management nodes, and the like.

As described in more detail below, in one implementation, the IP-PBX associates a given wireless client with the camp-on feature by registering the wireless client with the WCRTA, which informs the IP-PBX when a resource (i.e., a wireless access point) becomes available. In order to determine the availability of the resources, the WCRTA communicates with the ACM, which tracks the resources of one or more wireless access points. The WCRTA tracks the wireless client and the wireless access point with which the wireless client is associated. As described in more detail below, when the WCRTA determines that a resource becomes available, the WCRTA transmits a call back message (referred to as a camp-on resource available indication) to the IP-PBX, which in turn invokes the camp-on feature to connect the called and the calling wireless clients. In one implementation, if more than one wireless client is camping on a given resource, the WCRTA may maintain a list of such resources and serve them one by one. Actual implementation of the camp-on feature itself, once initiated as described herein, depends on the configuration of the IP-PBX and associated functionality.

D. Resource Reservation Message Flow (Called Wireless Client)

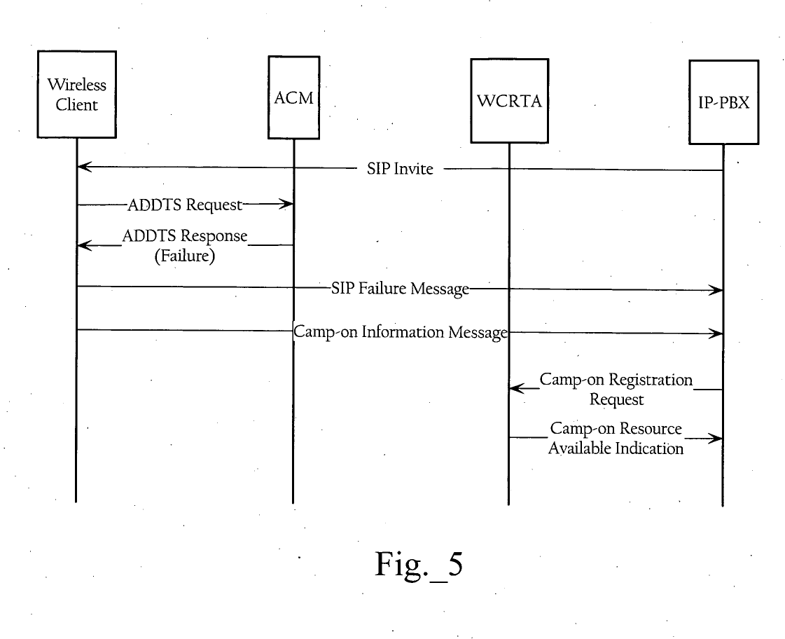

The following describes embodiments associated with the message flow with respect to a called wireless client. As described in detail below, when the wireless network infrastructure temporarily lacks resources to support the call, the wireless network infrastructure initiates the following message flow in connection with FIG. 5 below to associate the called wireless client with the camp-on feature.

D.1. Message Flow

FIG. 5 is a diagram illustrating a possible message flow among a called wireless client, an ACM, a WCRTA, and an IP-PBX in accordance with one implementation of the present invention. FIG. 5 illustrates one implementation where the IP-PBX transmits a session initiation message (e.g., a SIP invite) to a called wireless client when the calling wireless client attempts to call the called wireless client. The called wireless client transmits an over-the-air (OTA) bandwidth request (e.g., an ADDTS request for IEEE 802.11 WLANs) to attempt to reserve network resources for the call to the access control module. If sufficient resources for the call are unavailable, the ACM transmits an ADDTS response indicating a failure to reserve the requested resources for the wireless client. In one implementation, the ACM appends a camp-on information element (camp-on IE), which includes a WCRTA IP address, to the ADDTS response. In one implementation, the WCRTA IP address may be the same as the ACM IP address.

The called wireless client then transmits a SIP failure message and a camp-on information message to the IP-PBX. In one implementation, the SIP failure message and the camp-on information message may be combined into one message. In one implementation, the camp-on information message includes the WCRTA IP address (which was received in the ADDTS response), traffic stream parameters (e.g., TSPEC parameters) corresponding to the requested resources for the call, and the media access control (MAC) address of the called wireless client.

The IP-PBX then transmits a wireless client camp-on registration request to the WCRTA. The IP-PBX, in one implementation, also prompts the called wireless client to camp according to the camp-on functionality employed by the IP-PBX. In one implementation, the camp-on registration request includes the IP-PBX address, TSPEC parameters, the MAC address of the wireless client, and an expiration time. In one implementation, the camp-on registration request causes the WCRTA to track the wireless client and to inform the IP-PBX when sufficient resources become available. As discussed in more detail below, the WCRTA periodically polls the ACM to determine whether sufficient network resources are available. In one implementation, if the called wireless client roams, the WCRTA may poll the appropriate ACM for available resources, which is achievable since the WCRTA tracks the MAC address of the called wireless client by scanning one or more association tables of the wireless network infrastructure. When a resource becomes available, the WCRTA transmits a camp-on resource available indication to the IP-PBX to indicate that sufficient network resources are available for the call. The IP-PBX then invokes the camp-on feature to establish the call.

The following process flow diagrams illustrate the operations of the called wireless client, the WCRTA, and IP-PBX in connection with the message flow of FIG. 5.

D.1.a. Called Wireless Client

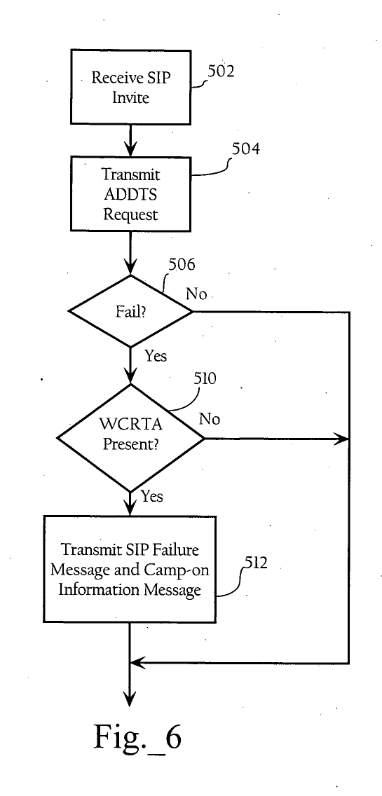

FIG. 6 is a flow chart illustrating a process flow, according to one implementation of the present invention, implemented at a wireless client. In one implementation, the wireless network interface driver presents one or more application programming interfaces (APIs) that allow higher level applications, such as a VoIP client, to selectively invoke the camp-on functionality described herein. As FIG. 6 illustrates, after a called wireless client (e.g., wireless client 60a) receives a SIP invite (502), called wireless client 60a transmits an ADDTS request to the ACM (504). Called wireless client 60a then determines if the ADDTS request failed (504) (i.e., if called wireless client 60a has received an ADDTS response indicating a failure). In one implementation, the ADDTS fails if the wireless access point does not have sufficient bandwidth or other resources to support a new call. If there is not a failure, called wireless client 60a continues with additional operations to establish the connection for the call. If there is a failure, called wireless client 60a determines if there is a WCRTA present (510). As described above, if the ADDTS response indicating a failure includes a camp-on information element (camp-on IE) (which includes a WCRTA IP address), then there is a WCRTA available. If there is no WCRTA present, called wireless client 60a continues with normal processes, such as transmitting a SIP failure response to the IP-PBX. If there is a WCRTA present, called wireless client 60a transmits a SIP failure response and transmits a camp-on message to the IP-PBX (512). As described above, in one implementation, the camp-on information message includes the WCRTA IP address, one or more requested TSPEC parameters, and the MAC address of called wireless client 60a. In one implementation, the IP-PBX transmits a request to the WCRTA identified in the camp-on information message, which causes the WCRTA to add the wireless client to a camp-on list.

D.1.b. Wireless Client And Resource Tracking Agent

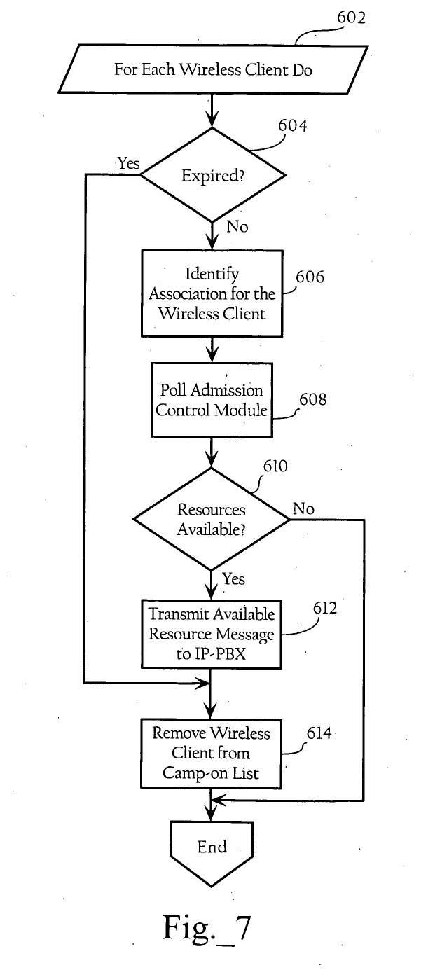

FIG. 7 is a flow chart illustrating a process flow, according to one implementation of the present invention, implemented at a WCRTA. As discussed below, WCRTA, in one implementation, loops through the camp on list and determines whether sufficient resources are available for the wireless clients on the camp-on list. As FIG. 7 illustrates, for each called wireless client registered with the WCRTA (602), the WCRTA determines if the camp-on request corresponding to the called wireless client has expired (604). If the WCRTA determines that the request associated with the called wireless client 60c on the camp-on list has expired (604), the WCRTA removes calling wireless client 60c from the camp-on list (614). If the camp-on request has not expired, the WCRTA identifies the wireless access point with which a given called wireless client 60a is associated (606) and polls the ACM corresponding to the wireless access point to determine whether sufficient resources are available (608). In one implementation, the WCRTA transmits the one or more TSPEC parameters to the ACM, which returns an indication of sufficient or insufficient resources. In one implementation, an association table provides a list of wireless clients and respective associated wireless access points. The WCRTA then determines if resources are available at the wireless access point (610) by making a request to the ACM, which performs operations to provide an answer. If resources are not available, the WCRTA continues to the next wireless client in the camp-on list. If/when sufficient resources are available, the WCRTA transmits an available resource message (e.g., a camp-on resource available indication) to the IP-PBX (612) indicating that one or more resources are available. The WCRTA then removes the called wireless client 60c from the camp-on list (614).

D.1.c. Internet Protocol—Private Branch Exchange

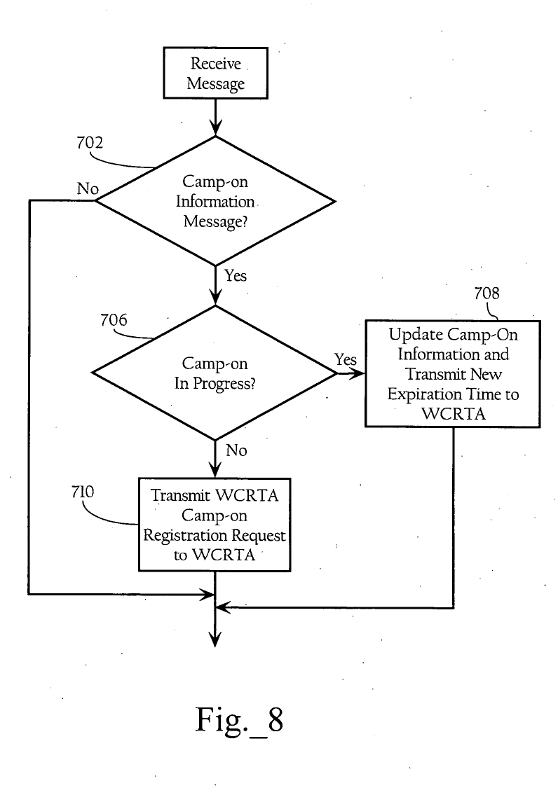

FIG. 8 is a flow chart illustrating a process flow, according to one implementation of the present invention, implemented at an IP-PBX. As FIG. 8 illustrates, the IP-PBX determines whether a received message is a camp-on information message (702). If not, the IP-PBX continues processing of the message as appropriate to the message type. If the IP-PBX has received a camp-on information message, the IP-PBX determines whether a camp-on for the wireless client identified in the camp-on information is in progress (706). If so, the IP-PBX updates the camp-on information for the wireless client (such as the expiration time) and transmits the updated information to the WCRTA (708). If a camp-on is not in progress, the IP-PBX transmits a camp-on registration request to the WCRTA (710). As above, the camp-on registration request can include an identifier (e.g., MAC address of the wireless client, one or more TSpec parameters, and an expiration time.

E. Resource Reservation Message Flows (Calling Wireless Client)

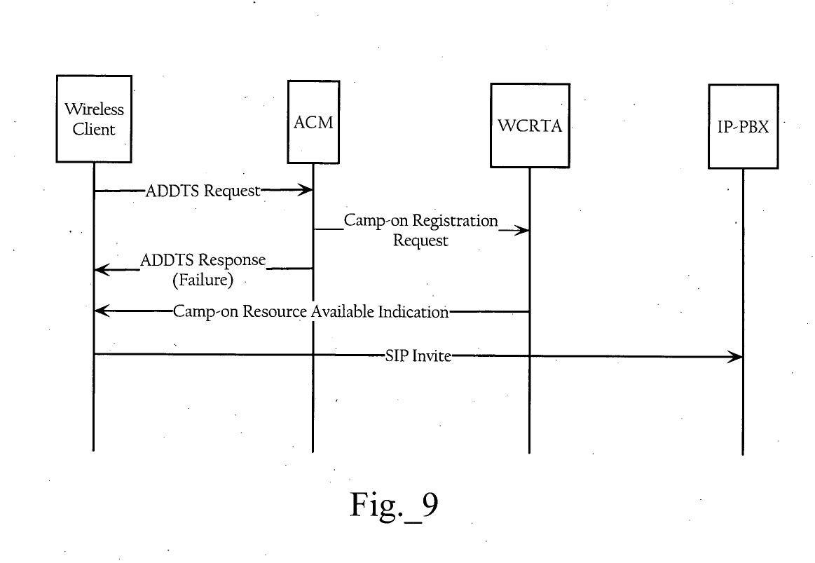

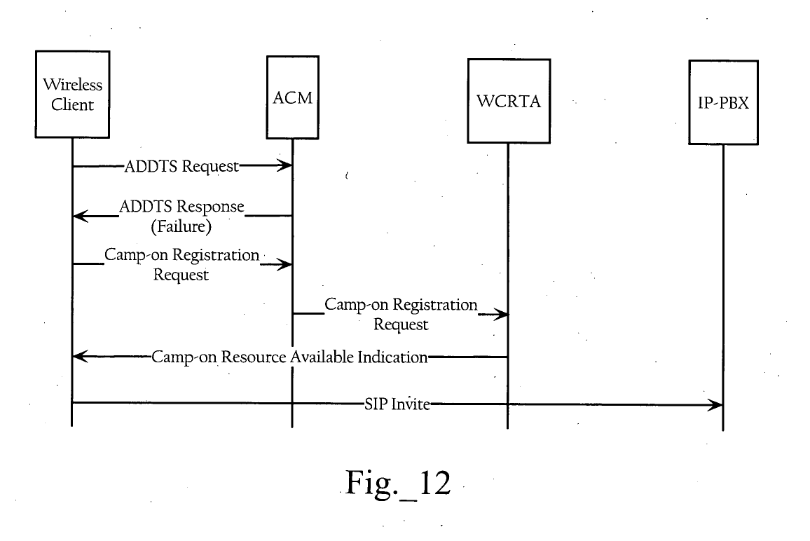

The following describes embodiments associated with a message flow with respect to a calling wireless client. As described in detail below, in one implementation, when the wireless network infrastructure temporary lacks resources to put a call through, the wireless network infrastructure initiates the camp-on message flow illustrated in FIG. 9 to activate the camp-on feature. In another implementation, the calling wireless client initiates the message flow as illustrated in FIG. 12 to activate the camp-on feature.

E.1. Camp-On Message Flow Initiated by Wireless Network Infrastructure

FIG. 9 is a diagram illustrating a possible message flow among a wireless client, an ACM, a WCRTA, and an IP-PBX in accordance with one implementation of the present invention. In one implementation, a wireless client is configured to transmit a bandwidth or QoS request (such as an ADDTS request) responsive to initiation of a VoIP call at the wireless client. FIG. 9 illustrates one implementation where a calling wireless client (e.g., wireless client 60c) appends a camp-on IE to an ADDTS request and then transmits the ADDTS request to a wireless network access point, which gets forwarded to the ACM. The ADDTS request includes one or more TSpec parameters defining the requested network resources for the call. The appended camp-on IE allows the ACM to invoke the camp-on feature without further interaction with the wireless client, if there are insufficient resources for the call. In one implementation, the camp-on IE includes the MAC address of calling wireless client 60c and an expiration time, so that if a resource does not become available after the expiration time expires, the ACM would not invoke the camp-on feature.

If there are insufficient resources to support the call, the ACM transmits a camp-on registration request to the WCRTA and transmits an ADDTS response indicating a failure to wireless client 60c. In one implementation, the camp-on registration request includes the camp-on IE (which includes the MAC address of the wireless client and, optionally, an expiration time) and one or more TSPEC parameters of the ADDTS request so that the WCRTA can track the ACM and the called wireless client 60a. The camp-on registration request, in one implementation, causes the WCRTA to add the calling wireless client to a camp-on list. In one implementation, if the camp-on feature is implemented on the wireless network, the ACM appends the camp-on IE to the ADDTS response to signal to the wireless client that the camp-on feature has been implemented. The camp-on IE includes a WCRTA IP address and indicates that the calling wireless client 60c may camp-on to the wireless network infrastructure (i.e., to the WCRTA). When resources become available, the WCRTA transmits a camp-on resource available indication to the calling wireless client 60c, and the calling wireless client 60c initiates the call, in one implementation, transmitting a SIP invite to the IP-PBX.

The following process flows illustrate the operations of the calling wireless client and the WCRTA in connection with the message flow of FIG. 9.

E.1.a Calling Wireless Client

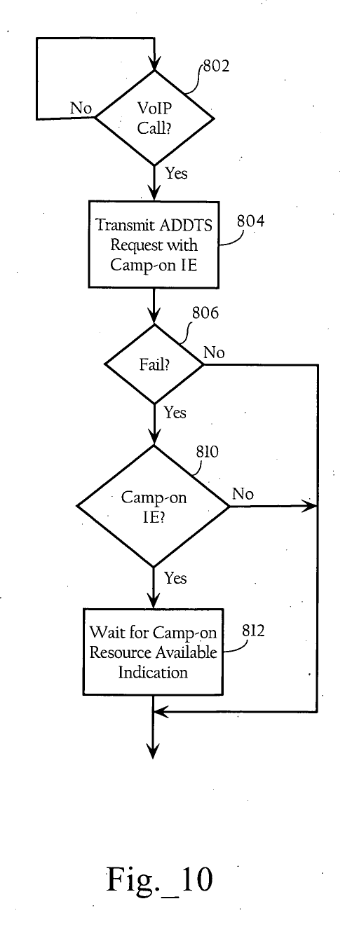

FIG. 10 is a flow chart illustrating a process flow, according to one implementation of the present invention, implemented at a wireless client. In one implementation, the wireless network interface driver presents one or more application programming interfaces (APIs) that allow higher level applications, such as a VoIP client, to selectively invoke the camp-on functionality described herein. As FIG. 10 illustrates, when a VoIP application of the calling wireless client initiates a call and invokes the camp-on feature (802), the wireless network interface driver of a calling wireless client 60c appends a camp-on IE to an ADDTS request and then transmits the ADDTS request to the wireless network (804). Calling wireless client 60c then determines if it has received an ADDTS response indicating a failure (806). If the ADDTS response indicates a failure to allocate sufficient resources for the call, calling wireless client 60c determines if there is a camp-on IE appended to the ADDTS response (810). If so, the calling wireless client 60c, in one implementation, waits for a camp-on resource available indication (812).

E.1.b. Wireless Client and Resource Tracking Agent

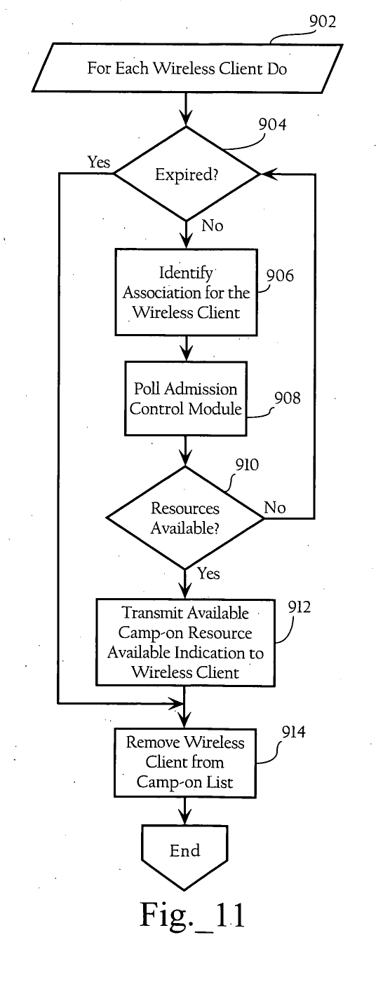

FIG. 11 is a flow chart illustrating a process flow, according to one implementation of the present invention, implemented at a WCRTA. As FIG. 11 illustrates, for each calling wireless client on the camp-on list (902), the WCRTA determines if the inclusion of the calling wireless client 60c on the camp-on registration request has expired. If not, the WCRTA identifies the wireless access point with which called wireless client 60a is associated (906) and polls the appropriate ACM against the one or more TSPEC parameters associated with the camp-on request to determine whether sufficient resources are available (908). In one implementation, an association table provides a list of called wireless clients and respective associated wireless access points. If sufficient resources are available at a given wireless access point (910), the WCRTA transmits a camp-on resource available indication to calling wireless client 60c (912). If resources are not available, the WCRTA checks if the inclusion of calling wireless client 60c has expired (904). In addition, if resources are available, the WCRTA removes calling wireless clients from the camp-on list (914) when the camp-on registration requests expire (904).

E.2. Camp-On Message Flow Initiated by the Calling Wireless Client

FIG. 12 is a diagram illustrating a possible message flow among a calling wireless client, an ACM, a WCRTA, and an IP-PBX in accordance with one implementation of the present invention. In one implementation, a wireless client is configured to transmit a bandwidth or QoS request (such as an ADDTS request) responsive to initiation of a VoIP call at the wireless client. In one implementation, a calling wireless client 60c appends a camp-on IE to an ADDTS request and transmits the ADDTS request to a wireless network access point, which gets forwarded to the ACM. Wireless client 60c then receives an ADDTS response from the ACM. In one implementation, the ACM appends a camp-on IE to the ADDTS response to indicate to calling wireless client 60c that the network infrastructure supports the camp-on feature. If the ADDTS request fails (i.e., calling wireless client 60c receives an ADDTS response indicating a failure), calling wireless client 60c transmits a camp-on registration request to a wireless network access point, which gets forwarded to the ACM, which then forwards the camp-on registration request to the WCRTA. In one implementation, the camp-on registration request includes the camp-on IE (which includes the MAC address of the called wireless client 60a and, optionally, an expiration time) and one or more TSPEC parameters of the ADDTS request so that the WCRTA can track to ACM and the called wireless client 60a. The camp-on registration request, in one implementation, causes the WCRTA to add the calling wireless client to a camp-on list. When resources become available, the WCRTA transmits a camp-on resource available indication to the calling wireless client 60c, and the calling wireless client 60c initiates the call, in one implementation, transmitting a SIP invite to the IP-PBX.

The following process flow illustrates the operations of the calling wireless client in connection with the message flow of FIG. 12.

E.1.a Calling Wireless Client

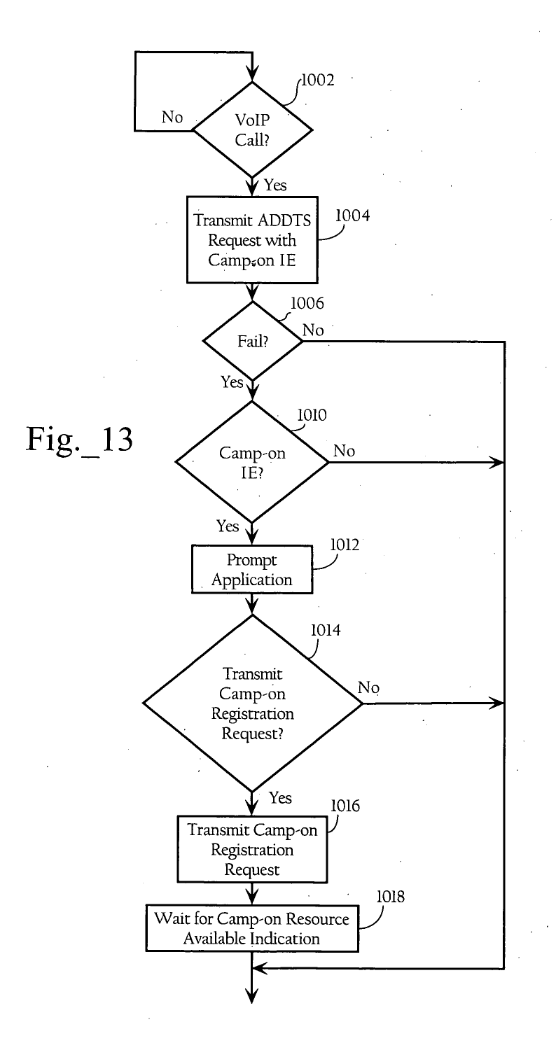

FIG. 13 is a flow chart illustrating a process flow, according to one implementation of the present invention, implemented at a wireless client. In one implementation, the wireless network interface driver presents one or more APIs that allow higher level applications, such as a VoIP client, to selectively invoke the camp-on functionality described herein. As FIG. 13 illustrates, when a VoIP application of the calling wireless client initiates a call and invokes the camp-on feature (1002), the wireless network interface driver of a calling wireless client 60c appends a camp-on IE to an ADDTS request and then transmits the ADDTS request to the wireless network (1004). Calling wireless client 60c then determines if it has received an ADDTS response indicating a failure (1006). If the ADDTS response indicates a failure to allocate sufficient resources for the call, calling wireless client 60c determines if there is a camp-on IE appended to the ADDTS response (1010). If there is a camp-on IE (1010), the driver of calling wireless client 60c prompts the wireless client application to prompt the user as to whether to camp-on (1012). Calling wireless client 60c then determines whether to transmit a camp-on registration request (1014). If so, calling wireless client 60c transmits the camp-on registration request (1016) and, in one implementation, then waits for a camp-on resource available indication (1018).

The present invention has been explained with reference to specific embodiments. For example, while embodiments of the present invention have been described as operating in connection with IEEE 802.11 networks, the present invention can be used in connection with any suitable wireless network environment. Still further, the present invention can operate in connection with other session initiation or signaling protocols, such as H.323. Furthermore, the camp-on feature can be implemented in connection with other network applications than VoIP, such as VoIP conference calls, multimedia broadcast streams, and the like. In addition, although implementations described above operate in connection with an IP-PBX, the present invention can operate with other VoIP, session initiation or session initiation or signaling nodes. Other embodiments will be evident to those of ordinary skill in the art. It is therefore not intended that the present invention be limited, except as indicated by the appended claims.

What is claimed is:

1. Logic for requesting wireless network resources, the logic encoded in one or more media for execution and when executed operable to:
transmit a network resource request to a wireless network in response to a session initiation message from a session signaling node; and
responsive to an indication that the wireless network lacks sufficient resources, conditionally transmit a camp-on information message to the session signaling node.

2. The logic of claim 1 wherein the indication comprises a network resource request failure response including a camp-on information element (camp-on IE) identifying a wireless network resource tracking agent.

3. The logic of claim 1 wherein the camp-on information message comprises one or more of a network address of a tracking agent, traffic stream parameters, and a network address of the wireless client.

4. The logic of claim 1 wherein the network resource request is an ADDTS request comprising one or more TSpec parameters.

5. The logic of claim 1 wherein the camp-on information message is appended to a response to the session initiation message.

6. The logic of claim 1 wherein the session initiation message is a SIP invite message.

7. A method for requesting wireless network resources, the method comprising:
transmitting a network resource request to a wireless network in response to a session initiation message from a session signaling node; and
responsive to an indication that the wireless network lacks sufficient resources, conditionally transmitting a camp-on information message to the session signaling node.

8. The method of claim 7 wherein the indication comprises a network resource request failure response including a camp-on information element (camp-on IE) identifying a wireless network resource tracking agent.

9. The method of claim 7 wherein the camp-on information message comprises one or more of a network address of a tracking agent, traffic stream parameters, and a network address of the wireless client.

10. The method of claim 7 wherein the network resource request is an ADDTS request comprising one or more TSpec parameters.

11. The method of claim 7 wherein the camp-on information message is appended to a response to the session initiation message.

12. The method of claim 7 wherein the session initiation message is a SIP invite message.

13. A method for requesting wireless network resources, the method comprising:
responsive to initiation of a session, transmitting a network resource request to a wireless network; and
responsive to an indication that the wireless network lacks sufficient resources, conditionally transmitting a camp-on registration request to the wireless network.

14. The method of claim 13 wherein the camp-on registration request includes information enabling the wireless network to invoke a camp-on feature without further interaction with the wireless client.

15. The method of claim 13 wherein the camp-on registration request comprises an address of the wireless client.

16. The method of claim 13 further comprising transmitting a camp-on registration request to the wireless network infrastructure node.

17. The method of claim 16 wherein the camp-on registration request comprises one or more of a camp-on IE and traffic stream parameters.

18. The method of claim 13 further comprising receiving a camp-on resource available indication.

19. The method of claim 13 wherein the wireless client is a calling wireless client.

20. Logic for managing wireless network resources, the logic encoded in one or more media for execution and when executed operable to:
access a camp-on registration request identifying a wireless client requesting resources from a wireless network for a session;
determine if sufficient resources are available at the wireless network for the session; and
transmit an available resource indication message to a requesting node when sufficient resources are available.

21. The logic of claim 20 wherein the logic is operable to identify a wireless access point with which a called wireless client is associated.

22. The logic of claim 20 wherein the logic is operable to poll an access control module of the wireless network.

23. The logic of claim 22 wherein the logic is operable to poll the access control module of the wireless network for traffic stream parameters.

24. The logic of claim 20 wherein the requesting node is an IP-PBX.

25. The logic of claim 20 wherein the requesting node is a wireless client.

26. A method for managing wireless network resources, comprising:
accessing a camp-on registration request identifying a wireless client requesting resources from a wireless network for a session;
determining if sufficient resources are available at the wireless network for the session; and
transmitting an available resource indication message to a requesting node when sufficient resources are available.

27. The method of claim 26 further comprising identifying a wireless access point with which a called wireless client is associated.

28. The method of claim 26 further comprising polling an access control module of the wireless network.

29. The method of claim 28 further comprising polling the access control module of the wireless network for traffic stream parameters.

30. The method of claim 26 wherein the requesting node is an IP-PBX.

31. The method of claim 26 wherein the requesting node is a wireless client.

32. Logic for implementing WLAN-integrated camp-on functions, the logic encoded in one or more media for execution and when executed operable to:
access a camp-on information message corresponding to a called wireless client; and
transmit a camp-on registration request to a wireless network infrastructure node;
connect the called wireless client and a calling node, responsive to an indication that wireless network resources are available.

33. The logic of claim 32 wherein the logic is operable to update and transmit an expiration time to the wireless network infrastructure node if a camp-on is in progress.

34. The logic of claim 32 wherein the camp-on information message comprises an address of a tracking agent, traffic stream parameters, and an address of a wireless client.

35. A method for implementing WLAN-integrated camp-on functions, the method comprising:
accessing a camp-on information message corresponding to a called wireless client;
transmitting a camp-on registration request to a wireless network infrastructure node; and
connecting the called wireless client and a calling node, responsive to an indication that wireless network resources are available.

36. The method of claim 35 further comprising updating and transmitting an expiration time to the wireless network infrastructure node if a camp-on is in progress.

37. The method of claim 35 wherein the camp-on information message comprises an address of a tracking agent, traffic stream parameters, and an address of a wireless client.

38. A system for implementing WLAN-integrated camp-on functions, the system comprising:
a wireless client operable to
transmit, responsive to initiation of a session, a network resource request to a wireless network infrastructure node; and
responsive to an indication that the wireless network lacks sufficient resources, conditionally transmitting a camp-on information message or a camp-on registration request; and
a wireless network element operative to
establish a wireless connection with a wireless client when sufficient resources are available;
transmit, when sufficient resources are unavailable for a session, an indication that sufficient resources are unavailable to a requesting wireless client; and
a resource tracking agent operative to
access a camp-on registration request identifying a wireless client requesting resources from a wireless network for a session;
determine if sufficient resources are available at the wireless network for the session; and
transmit an available resource indication message to a requesting node when sufficient resources are available.

39. The system of claim 38 further comprising
a session signaling node operative to
access a camp-on information message corresponding to a called wireless client; and
transmit a camp-on registration request to a wireless network infrastructure node;
connect the called wireless client and a calling node, responsive to an indication that wireless network resources are available.
